(19) United States
(12) Patent Application Publication
(10) Pub. No.: US 2012/0288591 A1
(43) Pub. Date: Nov. 15, 2012

(54) FILM COATED CONFECTIONERY PRODUCT

(75) Inventors: Steven M. KUMIEGA, Hummelstown, PA (US); Thomas J. CARROLL, Mechanicsburg, PA (US)

(73) Assignee: THE HERSHEY COMPANY, Hershey, PA (US)

(21) Appl. No.: 13/469,769

(22) Filed: May 11, 2012

Related U.S. Application Data
(60) Provisional application No. 61/485,819, filed on May 13, 2011.

(51) Int. Cl. A23G 3/54; A23G 3/36

(52) U.S. Cl. 426/92; 426/103; 426/303

(57) ABSTRACT

A film-coated confectionery product is disclosed in which a confectionery base includes or more film coated layers to impart one or more flavors, sensations, textures or combinations of these characteristics to the product when the product is consumed.

### RELATED APPLICATION

This application claims the benefit of and priority to U.S. Provisional Application No. 61/485,819 filed May 13, 2012, which is hereby incorporated by reference.

### FIELD

This application is directed to confectionery products and more particularly to confectionery products having film coatings.

### BACKGROUND

Confectionery products are often coated or enrobed with a candy or crunchy shell. In some cases, this may be to provide protection to a central edible core that might lack stability and/or be more susceptible to changes in the environment (e.g., heat and humidity) than the material used to provide the coating. In other cases, it may serve a less technical role, but still form an important part of the taste experience. Applying coatings, often referred to as hard-pan coatings, takes a long time to manufacture and produce. This time results in increased energy and other production costs.

While film coatings have long been used for pill coatings, pills are meant to be ingested quickly and minimize the time they are in contact with the taste buds, if at all. As a result, the film coating is applied as thin as possible around the pill to act as a neutral barrier to the bitter taste of most pills and/or as a lubricant to make the pill easier to swallow quickly. The coating is very thin, generally lasting just long enough to be swallowed and not interfere with absorption of the active ingredients in the underlying pill. This is contrary to confectionery products, which are meant to be savored and enjoyed in the mouth over a period of time and generally should be full of flavor.

These and other drawbacks exist in the art.

### SUMMARY

It would be desirable to provide a confectionery product having one or more film coatings to impart one or more flavors, textures, sensations or combinations of these and other characteristics when the product is consumed, which is accomplished by embodiments of the present invention.

In one embodiment, a film coated confectionery product is provided that includes a comestible core and a film coating that surrounds the comestible core. The film coating imparts a pre-determined epicurean characteristic to the confectionery product when consumed. In certain embodiments, the pre-determined epicurean characteristic is selected from the group consisting of flavor, texture, taste, sensation and combinations thereof.

According to another embodiment, a film coated confectionery product includes a comestible core, a first film coating that surrounds the comestible core, and a second film coating that surrounds the first film coating. Each of the first and second film coatings imparts a pre-determined epicurean characteristic to the confectionery product when consumed and at least one epicurean characteristic imparted by the first film coating is different than the epicurean characteristics imparted by the second film coating. In certain embodiments, the pre-determined epicurean characteristic is selected from the group consisting of flavor, texture, sensation and combinations thereof.

According to yet another embodiment, a method of making a film coated confectionery product is disclosed. The method includes providing a comestible core, applying an atomized liquid of a first composition to the comestible core to form a first film coated layer having a pre-determined epicurean characteristic, and applying an atomized liquid of a second composition to the comestible core to form a second film coated layer having a pre-determined epicurean characteristic different from the first film coated layer. The liquid may be an emulsion, suspension, or solution, depending upon the components used for the various compositions.

An advantage of certain embodiments is that a confectionery product is provided that has a good mouth-feel in combination with desirable food related characteristics so that the product can be savored and enjoyed by an individual consuming the product.

Another advantage is that in embodiments employing multiple film coated layers, different flavors, tastes, textures, intensities and sensations, as well as combinations and/or transitions between these characteristics, can be enjoyed in succession as part of a single confectionery product.

Still another advantage of certain embodiments is that a product having a good mouth-feel in combination with desirable food related characteristics can be created more efficiently than using traditional confectionery production methods.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWING

FIG. 1 is a perspective view of a film coated confectionery product according to an exemplary embodiment that is partially broken for purposes of illustration.

### DETAILED DESCRIPTION OF EXEMPLARY EMBODIMENTS

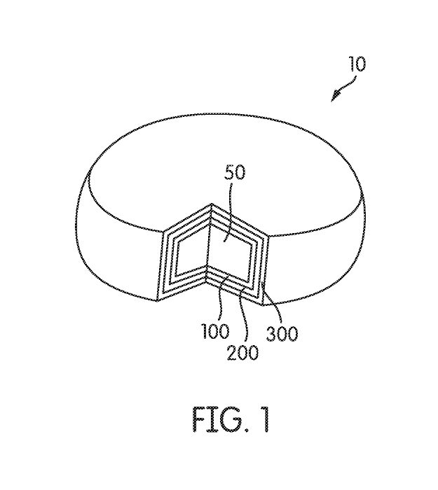

Turning to FIG. 1, a confectionery product 10 includes a comestible core 50 that is surrounded by a first film coating 100. In certain embodiments, the first film coating 100 is surrounded by a second film coating 200, which may itself be surrounded by a third film coating 300 or any other number of additional film coatings.

The comestible core 50 can be any edible material capable of being film coated. The core 50 may be of any shape or geometry, although the edges of the core 50 should generally be rounded or beveled to enhance the uniformity of thickness when the film coating is applied and which might not readily be achieved if shapes having sharp or well-defined edges are employed.

The core 50 is generally, but not necessarily, a pressed tablet. In one embodiment, the core 50 is a sugar base pressed tablet, while in another embodiment the pressed tablet has a polyol base, such as, but not limited to, sorbitol, mannitol, xylitol, isomalt, lactitol and combinations of these materials. The core 50 may be unflavored, but typically is flavored and may be, for example, a breath mint. In addition to pressed tablets, other exemplary cores include chewing gum, licorice, lozenges, fruit, nuts, malted milk balls, and chocolate, all by way of example only.

The comestible core 50 is surrounded by a first film coating 100 that is adjacent, but not necessarily in direct contact with, the comestible core 50. For example, in embodiments that employ a core 50 that is hygroscopic, it may be desirable to first coat the core 50 with a wax or other sealing material prior to applying the first film coating 100. In other embodiments, the first film coating 100 surrounds and is in direct contact with the core 50. By “surround” is meant that a film coating covers more than about 50% of the underlying surface said to be surrounded. That is, it will be appreciated that while in many embodiments the film coating will cover the entire surface of an underlying layer, it is not required to do so to fall within the scope of the present disclosure.

Each of the film coatings 100, 200, 300 is a polymer-based coating made from any suitable water-soluble, alcohol-soluble or other solvent-soluble, food grade (i.e. edible) polymeric film-forming material, whether natural or synthetic. Exemplary polymers for use in the film coating include, but are not limited to, hydroxypropyl methyl cellulose, hydroxypropyl cellulose, carboxymethyl cellulose, methyl cellulose, hydroxy ethyl cellulose, ethyl cellulose, gelatin, and combinations of these materials. The use of polymers such as ethyl cellulose and others known in the art as moisture barriers may provide added stability to the confectionery product, leading to longer shelf life, particularly in tropical climates.

At least one of the film coatings 100, 200, 300 further contains one or more additives to impart one or more pre-determined epicurean characteristics to the confectionery product when it is consumed. By “epicurean” is meant a characteristic that relates to a food property that can be sensed by the mouth such as flavor, texture, taste, sensation, intensity, and the like. Exemplary additives include flavorants to impart a flavor to the film coating layer; fine powders or other ingredients that may be used to impart a texture or mouth-feel, such as a grainy or creamy texture; sensates which may contain acids or other active ingredients to deliver a sensation, such as coolness, hotness, tingling, effervescence, and salivation, by way of example only; and tastants that impart tastes such as, bitter, salty, sweet, sour, umami and kokumi tastes.

Each film coating 100, 200, 300 may include multiple additives to impart multiple epicurean characteristics in a single layer. For example, the film coating may have a combination of additives to provide a mint flavor while also delivery a cooling sensation when the confectionery product 10 is consumed. It will be appreciated, however, that in some cases, depending on the additive, a single ingredient may be used to provide multiple epicurean characteristics.

Flavorants can be any natural or synthetic flavoring agents known in the food art and may be selected from synthetic flavor oils and flavoring aromatics, and/or oils, oleo resins and extracts derived from plants, leaves, flowers, fruits and the like. Combinations of these materials may also be used. Exemplary flavor oils include, but are not limited to, spearmint oil; cinnamon oil; oil of wintergreen (methylsalicylate); peppermint oil; clove oil; bay oil; anise oil; eucalyptus oil; thyme oil; cedar leaf oil; oil of nutmeg; oil of sage; oil of bitter almonds; cassia oil; citrus oil (e.g., lemon, lime, orange, grapefruit, etc.); grape oil; natural and synthetic flavorings like vanilla, cocoa and caramel; and fruit essences such as apple, banana, pear, peach, strawberry, raspberry, cherry, plum, pineapple, and apricot all by way of example only.

Preferably, the flavorant is an oil or liquid base composition. Powdered flavorants may also be used, but can increase the complexity of achieving an even distribution of flavor throughout the film coating and can also introduce a rugged or gritty texture in instances where a creamy or smooth texture may be desired. While the film coating contains a flavorant in most embodiments, it will be appreciated that flavoring is not required and that a particular film coating could be flavor neutral. A flavor neutral film coating may be particularly useful as an intermediate layer between two film coatings having diverse flavor profiles, such that the flavor neutral film coating allows a period of time to cleanse the palate between the flavorful film coatings.

Sensate compounds can include cooling agents, warming agents, tingling agents, effervescent agents, salivating agents and combinations thereof. Any food-grade acids or other ingredients known in the art for inducing a sensation when consumed can also be used. Exemplary such materials include, but are not limited to, citric acid, succinic acid, fumaric acid, malic acid and tartaric acid. Other exemplary sensate ingredients include menthol, xylitol, erythritol, dextrose, sorbitol, and mannitol can be used to impart a cool sensation due to negative heat of solution. Flavoring components that may also impart a cooling sensation include menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5] decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Symrise, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopropyl-bicyclo(2.2.1), Heptane-2-carboxamide; and Menthol methyl ether, and menthyl pyrrolidone carboxylate among others.

Other sensates include encapsulated products such as those sold under the tradenames Durarome®, Flexarome®, FirCaps® and Popscent®, which may also be used to impart a texture to the layer.

As illustrated in FIG. 1, certain embodiments have multiple film coatings 100, 200, 300. Where more than one film coating is present, the second film coating 200 typically has at least one epicurean characteristic that is different from the first film coating 100. That is, the second film coating 200, for example, provides at least a flavor, texture, taste, or sensation not found in the first film coating 100 so that a person consuming the confectionery product 10 can sense he or she is now consuming a different layer of the product 10. Where three or more layers are provided, the third film coating 300 can be different from the first and second film coatings 100, 200 or can be the same as the first or second film coating, for example, to create a back-and-forth transition effect. As also noted, in some embodiments having multiple layers of film coatings, one or more of the film coatings may have a neutral effect to provide a transition period between two film coatings having diverse flavors from one another.

Other additives in the film coating 100, 200, 300 may include a surfactant, plasticizer and/or an emulsifier to assist in the application of the film coating during manufacture, as more fully discussed subsequently.

Sweeteners may also be present in the film coating. Exemplary sweeteners include sucrose, as well as artificial sweeteners such as acesulfam-K, aspartame, sucralose, neotame, stevia, and xylitol, among others. If a sweetener is employed, it is preferable to use intense sweeteners which do not contain or employ dissolved sugars, which would have a tendency to make the film coating become crunchy and candy-like, which may impact mouth-feel and other characteristics of the confectionery product 10 in an undesirable manner.

Still other additives that may be employed in the film coating include colorants, stabilizers and/or preservatives to improve shelf life, and any other additives commonly used in other types of confectionery products.

Each film coating of the confectionery product 10 is at least about 65% by dry weight polymer and typically at least about 75% by dry weight polymer. In some embodiments, the film coating is at least about 90% by dry weight polymer and can be up to about 98% by dry weight polymer. The next most abundant ingredient in the film coating is typically that of the flavorant and/or other ingredients used to achieve the pre-determined epicurean characteristic for the coating, followed by the emulsifier/surfactant, then any optional sweeteners, colorants and other ingredients.

The thickness of each film coating 100, 200, 300 is such that the film coating is applied to at least about 2% of the weight of the core 50 (based upon the percent solids in the liquid mixture applied to create the film coating at the time of manufacture) and has a thickness greater than about 100 microns. In some embodiments, the film coating is at least about 5% by weight of the core 50, and in other embodiments the film coating is between about 10 and 15% by weight of the core 50 and still other embodiments may be up to about 20% by weight or more. It will be appreciated that in some embodiments, the liquid mixture may be provided as an emulsion, including the addition of an emulsifier or surfactant to achieve the emulsion, while in other cases the mixture may be provided as a suspension or solution depending upon the physical properties of the additives being added, as well as their miscibility with the water or other liquid that forms the base of the film coating prior to spraying.

In this manner, each of the one or more film coatings 100, 200, 300 can be independently designed to provide a particular, predetermined set of epicurean characteristics that is desired, then applied in succession over a confectionery core 50 to achieve a single confectionery product 10 that has multiple layers of taste experiences that can be enjoyed over time when consumed, i.e., by sucking or otherwise dissolving in the mouth. In some embodiments, the overall experience may be further enhanced by varying the weight percent solids of polymer (and thus the thickness) in different film coating layers and/or using different types or combinations of polymer in different film coating layers to vary the rate of dissolution of a particular film coating, and thus the amount of time one has a particular taste experience associated with one layer compared to another. For example, one film coating could be used to provide a short experience of cinnamon flavoring and/or hot sensation, followed by a different, longer lasting film coating having a mint flavoring and/or cooling sensation to accentuate the soothing effect experienced after the earlier layer.

Furthermore, because the nature of film coatings is such that the coatings act as barriers, the use of film coatings in accordance with exemplary embodiments of the invention can reduce or prevent the migration of flavor between film coating layers and/or to or from the core 50. In some cases, the reduction or prevention of flavor migration can be used advantageously to achieve abrupt changes in taste experience between one layer having a first set of pre-determined epicurean characteristics and second layer having a distinctly different set of pre-determined epicurean characteristics to further enhance the overall effect of the product.

It will be appreciated that increasing the weight percent of the film coating with respect to the core will result in thicker film coatings and which imparts a longer lasting coating in the mouth. As a result, the duration of how long the confectionery product 10 will last in the mouth before complete consumption by dissolution can be controlled by adjusting the weight of the film coating with respect to the core. Duration may also be adjusted by the polymer selected as the film forming material, as different polymers may have different dissolution profiles.

The confectionery product 10 can be made by employing general film coating techniques consistent with those that are used in the pharmaceutical industry in the production of film coated pills. More particularly with respect to exemplary embodiments, the comestible core 50 is provided in a rotating, perforated pan or drum through which a high volume of air or other gas is passed. A liquid mixture of the film coating ingredients and water, alcohol or other suitable solvent for the polymeric film-forming material is atomized and sprayed onto the core. The volume of air passing through the perforated pan is sufficiently large so as to quickly dry the solvent from the surface to which the mixture is applied. The solids remain on the surface of the core, forming the film coating. This process is repeated for each different layer that is to be applied, with subsequent film coating mixtures being atomized and sprayed to form subsequent layers overlying earlier applied layers.

The liquid mixture to be atomized in accordance with exemplary embodiments may be a suspension, solution or emulsion, the form of which may depend on a variety of factors, including whether the additives to be used with the film coating are water or oil based, soluble in water and/or whether any solid particles are incorporated as inclusions. If an emulsion is employed, an oil-in-water emulsion may be formed using the film coating ingredients and water, with the water present at up to 80% or more by weight of the emulsion at the time the first film coating 100 is applied. The viscosity of the emulsion should be less than about 200 cPs at 40° C.

To minimize or eliminate volatilization of oil-base or solvent-based flavorants and other ingredients, the atomization of the oil-in-water emulsion should be on the scale of micron-size particles to ensure that adequate flavorant is deposited with the solids as part of the film coating, rather than being evaporated and carried away with the water vapor. Similar atomization sizing should also be employed with the application of solutions or suspensions.

The use of such film coatings 100, 200, 300 has the further advantage of providing a confectionery product 10 that has a pleasing mouth-feel. In embodiments in which ingredients to impart texture are not used, it can further result in an extremely smooth surface not currently found in other confectionery products.

### EXAMPLES

The invention is further described in the context of the following examples, which are presented by way of illustration, not of limitation.

### Example 1

Pressed sorbitol tablets were sprayed with an atomized oil-in-water emulsion in a perforated drum through which high velocity air was passed. The water phase was an aqueous solution of a hydroxypropylmethyl cellulose (HPMC) based film coating material commercially available under the tradename Aquarius BG 19111 from Ashland Chemical. The oil phase was peppermint oil provided to impart flavor and sensation and which was present as about 1% by weight of the emulsion. Samples of film coated confectioneries were formed having a film coating at each of 3%, 6%, 10% and 15% by weight solids with respect to the tablet weight (i.e., the solids in the final film coating was 3%, 6%, 10% and 15% respectively of the tablet weight).

### Example 2

Pressed isomalt tablets were sprayed with an atomized oil-in-water emulsion in a perforated drum through which high velocity air was passed. The water phase was an aqueous solution of a hydroxypropylmethyl cellulose (HPMC) based film coating material commercially available under the tradename Aquarius BG 17104 from Ashland Chemical. The oil phase was peppermint oil provided to impart flavor and sensation and which was present as about 1% by weight of the emulsion. Samples of film coated confectioneries were formed having a film coating at each of 3%, 6%, and 10% by weight solids with respect to the tablet weight (i.e., the solids in the final film coating was 3%, 6%, and 10% respectively of the tablet weight).

The film coated confectionery products formed according to the examples exhibited a flavorful peppermint taste as the film coating slowly dissolved, with the tablets having a higher weight percentage of film coating providing a more slowly dissolving coating prior to reaching the underlying core.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A confectionery product comprising
a comestible core;
a film coating that surrounds the comestible core comprising at least about 75% by weight of a food grade polymer,
wherein the film coating imparts a pre-determined epicurean characteristic to the confectionery product.

2. The confectionery product of claim 1, wherein the pre-determined epicurean characteristic is selected from the group consisting of flavor, texture, taste, sensation and combinations thereof.

3. The confectionery product of claim 1, wherein the film coating comprises hydroxypropyl methyl cellulose, hydroxypropyl cellulose, carboxymethyl cellulose, methyl cellulose, hydroxy ethyl cellulose, ethyl cellulose, gelatin, or combinations thereof.

4. The confectionery product of claim 1, wherein the film coating comprises a flavorant.

5. The confectionery product of claim 1, wherein the film coating comprises an ingredient that modifies a texture of the film coating.

6. The confectionery product of claim 1, wherein the film coating comprises a sensate.

7. The confectionery product of claim 1, wherein the film coating is at least about 85% by weight of a food grade polymer.

8. The confectionery product of claim 1, wherein the film coating is present in the confectionery product as at least about 2% by weight of the comestible core.

9. The confectionery product of claim 1, wherein the film coating is present in the confectionery product as between about 10% and 20% of the comestible core.

10. The confectionery product of claim 1, wherein the film coating is a first film coating and wherein the confectionery product comprises a second film coating surrounding the first film coating.

11. A confectionery product comprising
a comestible core;
a first film coating that surrounds the comestible core; and
a second film coating that surrounds the first film coating;
wherein the first film coating imparts a first pre-determined epicurean characteristic to the confectionery product and wherein the second film coating imparts a second pre-determined epicurean characteristic to the confectionery product that is different from that of the first film coating.

12. The confectionery product of claim 11, wherein the first and second pre-determined epicurean characteristics are each selected from the group consisting of flavor, texture, taste, sensation and combinations thereof.

13. The confectionery product of claim 11, wherein each of the first and second film coatings independently comprises hydroxypropyl methyl cellulose, hydroxypropyl cellulose, carboxymethyl cellulose, methyl cellulose, hydroxy ethyl cellulose, ethyl cellulose, gelatin, or combinations thereof.

14. The confectionery product of claim 11, wherein each of the first and second film coatings comprises a flavorant.

15. The confectionery product of claim 11, wherein at least one of the first or second film coatings is at least about 85% by weight of a food grade polymer.

16. The confectionery product of claim 11, wherein at least one of the first or second film coatings is present in the confectionery product as between about 10% and 20% by weight of the comestible core.

17. The confectionery product of claim 11, further comprising a third film coating surrounding the second film coating.

18. The confectionery product of claim 11, wherein the comestible core is a pressed tablet.

19. A method of making a confectionery product comprising
providing a comestible core;
applying an atomized mixture of a first composition to the comestible core to form a first film coated layer having a pre-determined epicurean characteristic; and
applying an atomized mixture of a second composition to the comestible core to form a second film coated layer having a pre-determined epicurean characteristic different from the first film coated layer.

20. The method of claim 19, wherein each of the first and second compositions comprise about 85% dry weight of a food grade polymer and wherein each of the first and second composition are applied such that the solids in the composition are between about 10% and 20% by weight of the comestible core.
